(19) United States
(12) Patent Application Publication
(10) Pub. No.: US 2017/0302140 A1
(43) Pub. Date: Oct. 19, 2017

(54) ELECTRONICALLY COMMUTATED DIRECT CURRENT MOTOR

(71) Applicant: BÜHLER MOTOR GMBH, Nurnberg (DE)

(72) Inventor: Richard Guttenberger, Greding (DE)

(73) Assignee: BÜHLER MOTOR GMBH, Nürnberg (DE)

(21) Appl. No.: 15/483,034

(22) Filed: Apr. 10, 2017

(30) Foreign Application Priority Data
Apr. 15, 2016 (DE) 10 2016 206 399.5

(51) Int. Cl. H02K 15/02; H02K 5/02; H02K 1/27

(52) U.S. Cl. CPC H02K 15/02; H02K 1/2706; H02K 5/02

(57) ABSTRACT

The invention relates to an electronically commutated direct current motor comprising a housing consisting of a plastic material, a wound stator, a rotor and a bearing shield consisting of a plastic material. The DC motor has a connection between the bearing shield and the housing or cover and housing or add-on part and housing, whereby no additional connecting or sealing elements are necessary and a very strong and tight connection can be established.

### BACKGROUND OF THE INVENTION

### (1) Field of the Invention

The invention relates to an electronically commutated direct current motor having a plastic housing.

### (2) Description of Related Art Including Information Disclosed Under 37 CFR 1.97 and 1.98

From DE 10 2009 047 332 A1, a generic direct current (DC) motor is known in which various parts are welded to the plastic housing. However, it is not apparent how the joining partners have to be shaped and how the welding process is to take place.

### BRIEF SUMMARY OF THE INVENTION

The present invention relates to an electronically commutated direct current motor comprising a housing consisting of a plastic material, a wound stator, a rotor and a bearing shield consisting of a plastic material.

The object of the invention is to provide a generic DC motor for a connection between the bearing shield and the housing or cover and housing or add-on part and housing, whereby no additional connecting or sealing elements are necessary and a very strong and tight connection can be established.

Due to the difference in diameter between the outer diameter of the bearing plate and the inner diameter of the housing, a pre-stress between the bearing plate and the housing is produced. When the welding regions heat up, this pre-stress leads to the melting of a welding region and to a close connection of the joining partners, since these can move slightly towards one another.

It is particularly advantageous if the welding regions and the width of a laser beam are coordinated with one another so that no non-heated partial regions are possible in the joining region. The diameter of the housing should be able to be reduced completely.

The laser beam welding method is particularly suitable for the welded connection, the housing (5), at least in the housing welding region has housing material that is permeable for laser beams. A laser beam of suitable wavelength can radiate through the wall without appreciably heating the housing (5).

According to a first embodiment, the bearing plate, at least in the bearing plate welding region, can consist of a laser light absorbing material or a laser light absorbing coating. The incoming laser beam is largely absorbed at the surface or in the region near the surface and converted into heat. This is also transmitted to the housing and melts both the welding region of the bearing shield and the welding region of the housing. Once the material is sufficiently soft, the connection releases and the welding areas mix and form a close connection which, after cooling, leads to a very strong mechanical connection, which is also very tight.

The object of the invention is also achieved by a method. In this case, a pre-assembled DC motor, in which the bearing plate is pressed into the housing, is irradiated with a laser beam while a relative feed movement is carried out in the circumferential direction of the housing. Either the laser beam or the DC motor can move. At a rotationally symmetrical weld, it is easiest to let the DC motor rotate.

In order to achieve a high quality of the welded connection, the welding regions and the width of a laser beam are to be coordinated with each other so that no non-heated partial regions are possible in the joining region. The diameter of the housing should thereby be able to be reduced completely in order to be able to form an intimate connection with the bearing shield. For this purpose, the laser beam can carry out an alternating movement in a direction parallel to a motor axis, while the feed movement is performed at a right angle thereto.

As an alternative to the use of different joining partners, it is also possible to carry out both joining partners from a material essentially permeable to the laser light. In this case, special measures are required in order to establish a sufficiently strong and tight connection. The laser beam should be very well focused and its highest energy density should be concentrated in the weld. In order to nevertheless achieve a secure weld connection, the laser beam must also be influenced in such a way that the range of highest energy density is modulated in the z direction. At the same time, care must be taken that the surface of the housing is not deformed. Therefore, an excessively high-energy input cannot occur in the region close to the surface. The welding device used therefore has an adjustable lens mechanism in which a collimation lens or a focusing lens performs an oscillation movement along the z-axis. The degree of transmission or absorption is selected in such a way that sufficient heating of the welding point is possible without damaging the surface of the housing. An infrared laser is suitable for the described welding process from the wavelength range between 0.7 and 2.5 micrometers.

A further effective measure is to modify the laser beam by means of an optical system in such a way that it has an annular or ellipsoidal beam cross-section on the surface which is focused to a circular area or a point as far as the welding area. As a rule, a laser beam leaves the radiation source with a Gaussian radiation profile in which the maximum of the radiation is in the beam center. It is desirable in this case to move the radiation maximum in an annular region, with a minimum of the radiation intensity prevailing at the center of the radiation cone. On the surface, the laser radiation is therefore distributed over a large surface area, but it meets in the welding area in a small circular area—idealized in one point. Even with a low absorption rate of approximately 10 to 20%, sufficient heat can be generated thereby to produce a welded connection.

It is also possible to use more than one laser beam directed at the welding area at different angles of incidence, the beam cross sections of the different laser beams not overlapping or only slightly overlapping the surface of the housing, but creating an additional radiation intensity in the welding area sufficient for a welded connection.

### BRIEF DESCRIPTION OF THE SEVERAL VIEWS OF THE DRAWINGS

The invention is better understood by reading the following Detailed Description of the Preferred Embodiments with reference to the accompanying drawing figures, in which like reference numerals refer to like elements throughout, and in which:

FIG. 1 is a sectional view through a DC motor according to the invention;

FIG. 2 shows an enlarged detail A from FIG. 1; and

FIG. 3 shows an enlarged detail B from FIG. 1.

Reference characters with index and corresponding reference characters without apostrophes denote identical details in the drawings and drawing description. It may also be the use in another embodiment, the prior art or a variant. For the sake of simplicity, the description introduction, and the reference character list contain only reference characters without index.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

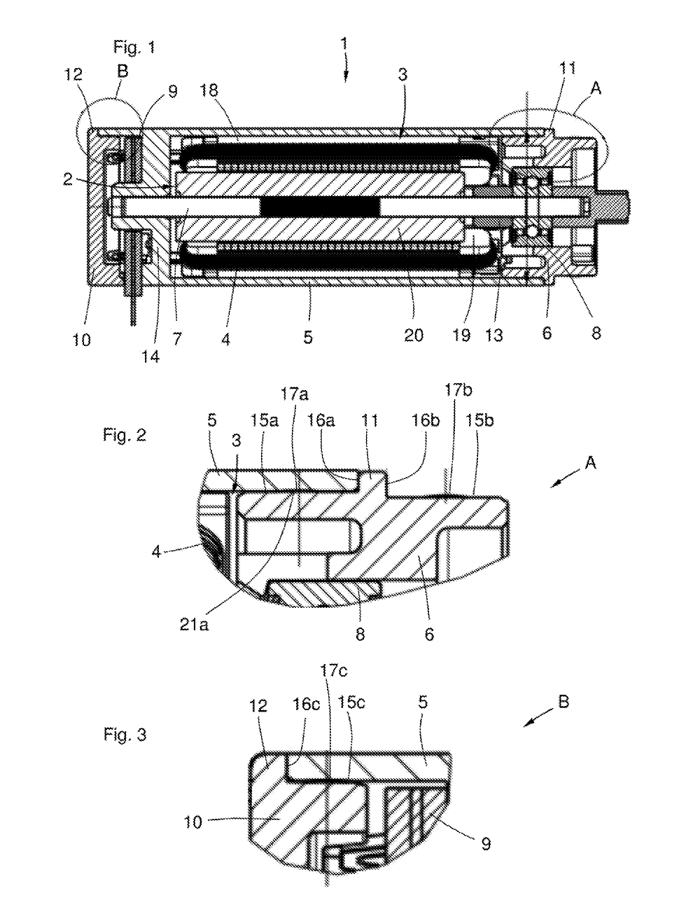

FIG. 1 shows a sectional view through a DC motor 1 according to the invention, with a housing 5, a stator 3, a bearing shield 6, a rotor 2, an intermediate wall 14, a printed circuit board 9 and a housing cover 10. The stator 4 comprises a stator laminate package 18, a stator insulation 19 and a stator winding 4. The rotor 2 comprises a hollow-cylindrical permanent magnet 20, a shaft 7 and a spacer bush 13, and is rotatively supported in an intermediate wall 14 on the one hand and in a ball bearing 8 in the bearing shield 6 on the other hand. The bearing shield 6 has a collar 11 on which the housing 5 closely fits axially.

FIG. 2 shows an enlarged detail A from FIG. 1 with the bearing shield 6, the ball bearing 8, the stator 3, the stator winding 4 and the housing 5. The bearing shield 6 comprises the collar 11, which is axially bounded by a first shoulder surface 16a and a second shoulder surface 16b, a first shank 15a and a second shank 15b. The first and second shanks 15a, 15b have bearing plate weld sections 17a, 17b that are formed as enlarged diameter sections. The outer diameter of the bearing plate welding section 17a is larger than the inner diameter of the housing welding section 21 before assembly. The housing 5 and the bearing shield 6 overlap axially in the region of the shank 15a and the housing 5 closely fits against the first shoulder surface 16a. The second shank 15b serves to secure an attachment part. The add-on part can be a gearbox or a pump.

It is possible to weld a ring gear of a planetary gear directly onto the shank 15b of the bearing plate 6. For this purpose, the bearing plate welding region 17b is provided. The outer diameter of the bearing plate welding section 17b is larger than the inner diameter of a ring gear welding section before assembly. After pressing the bearing plate 6 into the housing 5, these components are braced against one another. The bracing partially dissolves by heating and melting the welding regions 17a and 21a. In this case, the two parts radially approach one another towards the other and are closely connected to each other. A hermetically sealed weld seam is produced when a fully welded seam is produced. The shoulder surface 16b serves as an axial limit for the ring gear.

FIG. 3 shows an enlarged detail B from FIG. 1, with the housing 5, the housing cover 10 and the printed circuit board 9. The housing cover 10 has a flange-like edge 12, which is delimited by a shoulder surface 16c. The housing 5 bears axially against the shoulder surface 16c and is integral with the intermediate wall 14. The housing 5, the intermediate wall 14 and the housing cover 10 form a receiving space for the printed circuit board 9. Furthermore, the housing cover comprises a shank 15c, which has a bearing plate welding region 17c. The outer diameter of the bearing plate welding region 17c is larger than the inner diameter of a housing welding region 21 in the region of contact before assembly.

It is to be understood that the present invention is not limited to the illustrated embodiments described herein. Various types and styles of user interfaces may be used in accordance with the present invention without limitation. Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

### LIST OF REFERENCE SYMBOLS:

1 Direct current motor
2 Rotor
3 Stator
4 Stator winding
5 Housing
6 Bearing plate
7 Shaft
8 Ball bearing
9 Circuit board
10 Housing cover
11 Collar
12 Edge
13 Spacer bushing
14 Partition (component of the housing)
15 Shank
16 Shoulder surface
17 Bearing plate welding region
18 Stator lamination stack
19 Stator insulation
20 Permanent magnet
21 Housing welding area

What is claimed is:

1. Electronically commutated DC motor comprising:
a housing made of a plastic material and having a housing welding region;
a wound stator;
a rotor rotatable about a motor axis; and
a bearing plate consisting of a plastic material, wherein the bearing plate in pre-assembly condition has a bearing plate welding region, the outer diameter of which is larger than the inner diameter of the housing in the housing welding region.

2. The DC motor according to claim 1, wherein the width of the welding regions and the width of a laser beam are coordinated with each other.

3. The DC motor according to claim 1, wherein the housing at least in the housing welding region consists of a material which is permeable to laser beams.

4. The DC motor according to claim 3, wherein the bearing plate at least in the bearing plate welding region consists of a material that absorbs the laser light.

5. The DC motor according to claim 3, wherein the bearing plate at least in the bearing plate welding region consists of a material which has a laser light absorbing coating.

6. The DC motor according to claim 3, wherein the bearing plate is at least permeable to the same laser beams in the bearing plate welding region.

7. Electronically commutated DC motor comprising:
a housing made of a plastic material and having a housing welding region;
a housing cover secured to the housing;
a wound stator;
a rotor rotatable about a motor axis; and
a bearing plate consisting of a plastic material, wherein the housing cover in pre-assembly condition has a bearing plate welding region, the outer diameter of which is larger than the inner diameter of the housing in the housing welding region.

8. The DC motor according to claim 7, wherein the width of the welding regions and the width of a laser beam are coordinated with each other.

9. The DC motor according to claim 7, wherein the housing at least in the housing welding region consists of a material which is permeable to laser beams.

10. The DC motor according to claim 9, wherein the bearing plate at least in the bearing plate welding region consists of a material which absorbs the laser light, or has a laser light absorbing coating.

11. The DC motor according to claim 9, wherein the bearing plate at least in the bearing plate welding region consists of a material which absorbs the laser light, or has a laser light absorbing coating.

12. The DC motor according to claim 9, wherein the bearing plate is at least permeable to the same laser beams in the bearing plate welding region.

13. A method for producing an electronically commutated DC motor having a housing consisting of a plastic material, a wound stator, a rotor and a bearing plate consisting of a plastic material, the method comprising the steps of:
a) providing the pre-assembled DC motor, with bearing shield pressed into the housing; and
b) irradiating the housing with a laser beam, the laser beam carrying out a relative advancing movement in the circumferential direction of the housing.

14. The method according to claim 13, wherein during the feed movement the laser beam performs an alternating movement in a direction parallel to the motor axis.

15. The method according to claim 13, wherein the laser beam performs a modulated movement in the z-direction during the welding process.

16. The method according to claim 13, wherein the laser beam is modified by an optical system in such a way that it has on the surface an annular or ellipsoidal beam cross section which is focused to a circular area or a point as far as the welding area.

17. The method according to claim 13, wherein more than one laser beam is directed to the welding region at different angles of incidence, the beam cross sections of the different laser beams not overlapping on the surface of the housing.
